(19) United States
(12) Patent Application Publication
(10) Pub. No.: US 2002/0176114 A1
(43) Pub. Date: Nov. 28, 2002

(54) Method for utilizing a fragile watermark for enhanced security

(75) Inventors: Claude Zeller, Monroe, CT (US); Donald MacKay, Roxbury, CT (US); William Kilmartin, West Haven, CT (US); William A. Brosseau, Stratford, CT (US); James Euchner, Waccabuc, NY (US); Robert A. Cordery, Danbury, CT (US)

Correspondence Address: Pitney Bowes Inc., Intellectual Property and Technology Law Dept., 35 Waterview Drive, P.O. Box 3000, Shelton, CT, 06484, US

(73) Assignee: Pitney Bowes Incorporated, Stamford, CT

(21) Appl. No.: 10/087,314

(22) Filed: Mar. 1, 2002

Related U.S. Application Data
(60) Provisional application No. 60/283,565, filed on Apr. 13, 2001.

(51) Int. Cl. G06K 9/00

(52) U.S. Cl. 358/3.28; 382/100; 382/101

(57) ABSTRACT

A method that detects when an image is copied or scanned in order to reduce the production of fraudulent images. The invention allows an inspector to conduct an analysis of an image with a simple set of tools on site without the need to check a remote database through a network and look for duplicate images. This minimizes the infrastructure and cost required to implement the system. A local inspection can be made by scanning an image and decoding it with relatively inexpensive tools available on site. The invention accomplishes the foregoing by producing a fragile watermark image that produces a noticeable and measurable loss of information when it is reproduced. The loss of information is due to effects associated with scanning and printing processes.

This Application claims the benefit of the filing date of U.S. Provisional Application No. 60/283,565 filed Apr. 13, 2001, which is owned by the assignee of the present Application.

### CROSS REFERENCE TO RELATED APPLICATIONS

Reference is made to commonly assigned copending patent application Docket No. F-290 filed herewith entitled “Method For Embedding Information In An Image” in the names of Claude Zeller, Robert A. Cordery, Donald G. Mackay and William A. Brosseau; and Docket No. F-285 filed herewith entitled “Method For Reading Information That Has Been Embedded In An Image” in the names of Robert A. Cordery, Claude Zeller, Donald G. Mackay and William A. Brosseau.

### FIELD OF THE INVENTION

The subject invention relates to a method for printing images that contain information and, more particularly, to a method that detects when the printed images containing information are copied.

### BACKGROUND OF THE INVENTION

Images such as postal indicia have been printed by postage meters to evidence that the appropriate postage has been affixed to the mailpiece. A typical postal indicia includes fixed elements such as city name, state, a graphic, meter serial postal indicia includes fixed elements such as city name, state, a graphic, meter serial number, etc., and variable information such as date, postage amount, an encrypted number, etc. Postal indicia have been printed by flat bed printers and rotary printers without encryption and by ink jet printers with encryption. The improvements to photocopying, printing and scanning equipment have made it easier to commit fraud by copying postal indicia.

Currently, ticketing companies are giving purchasers the option of printing their electronic tickets at home, using ordinary paper, a personal computer printer and an Internet connection. One of the problems in allowing people to print tickets at home is how to ensure that the tickets are not counterfeited. One of the solutions suggested to solve the foregoing problem is to print an encrypted bar code on the ticket. Unfortunately, a ticket printed on ordinary paper with an encrypted bar code can be photocopied, and the seller of the ticket will be unable to distinguish between the original, genuine ticket and the photocopied ticket.

Many other types of value documents are currently being utilized. Unfortunately, it is anticipated that as sophisticated image processing equipment becomes more prevalent, the incidence of counterfeiting will increase. Currently, the United States Postal Service is embedding information in a two-dimensional bar code called an Information-Based Indicia (IBIP). The process of finding copies of an IBIP involve scanning a mailpiece containing an IBIP; decoding the unique IBIP with bar code reading software; connecting a system to a data base in order to locate an identical IBIP image; and determining whether or not the scanned image is a duplicate, i.e., copy of a paid for IBIP or a unique IBIP, i.e. a paid for IBIP.

Some disadvantages of the IBIP system, and other similar systems operating on the same principals, are that they are fully effective only if all images entering the system are scanned and analyzed, looking for duplicates in a database. If only a small number of images is processed, then the likelihood of finding duplicates is diminished, and the effectiveness of the system is reduced. For example, if the counterfeit rate is 1/1000 and only one of every one thousand images is scanned, then the odds of finding a single copy is 1/1000*1/1000 or one in a million.

### SUMMARY OF THE INVENTION

This invention overcomes the disadvantages of the prior art by providing a method that makes it more difficult to copy images. The invention provides a method that detects when an image is copied in order to reduce the production of fraudulent images. The invention allows an inspector to conduct an analysis of an image with a simple set of tools on site without the need to check a remote database through a network to look for duplicate images. This minimizes the infrastructure and cost required to implement the system. A local inspection can be made by scanning an image and decoding it with relatively inexpensive tools available on site. The invention accomplishes the foregoing by producing a fragile watermark image that produces a noticeable and measurable loss of information when it is reproduced. The loss of information is due to effects associated with scanning and printing processes.

### BRIEF DESCRIPTION OF THE DRAWINGS

FIG. 1-A is a drawing of a fragile watermark embedded in an image.

FIG. 1-B is a drawing of a copy of FIG. 1-A.

FIG. 2-A is a drawing showing a non-printed bit map image file magnified view of portion 20 of image 11.

FIG. 2-B is a drawing showing magnified view portion of 20 of image 11 printed with an ink jet printing device from an image file generated by scanning the original print.

FIG. 3 is a graph of copy detection vs. signal strength.

### DETAILED DESCRIPTION OF PREFERRED EMBODIMENTS OF THE INVENTION

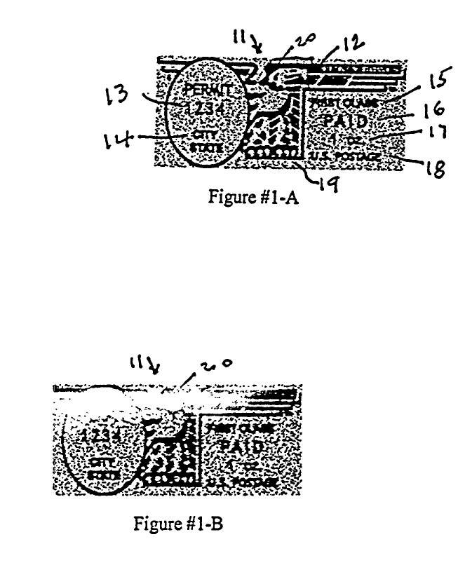

Referring now to the drawings in detail, and more particularly to FIG. 1, the reference character 11 represents a postal image. Postal image 11 includes graphic material in the form of an eagle 12, a permit number 13, a city, state 14, an indication of the class of postage 15, an indication that the postage has been paid 16, the weight of the mail piece 17, and the country 18. Black and white pixels 19 are embedded in image 11. Eagle 12 has a portion 20. The digital form of image 11 will suffer no loss of information when reproduced in digital format.

FIG. 1-B is a drawing of a copy of FIG. 1-A.

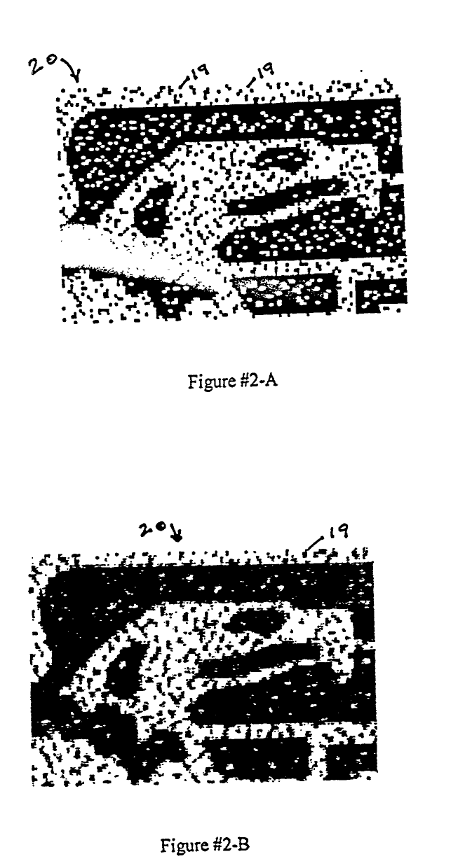

FIG. 2-A is a drawing showing a non-printed bit map image file magnified view of portion 20 of image 11.

FIG. 2-B is a drawing showing magnified view portion of 20 of image 11 after printing the image file shown in FIG. 2-A. Portion 20 of FIG. 2-B has been printed with an ink jet printing device and scanned. It can be seen that the printed image is an approximation of the original and has been distorted by the way in which the ink and paper interact and the ability of the printer to accurately position the drops of ink used to create the image. The amount of distortion is a function of the resolution of the printer, the size of the ink drops, and the way in which the ink spreads when it contacts the paper due to capillary and surface forces. These forces are associated with the fluid and physical properties of the ink and paper and are present in all ink-based printing systems. In particular, it can be seen how the ink tends to fill in small areas that were blank (white) in the original bit map representation of the image. This image distortion leads to a loss of information when the image is decoded. Other non-ink based printing systems experience similar image degradation that leads to information loss due to process variables. An example of the foregoing is the static charge properties of toner, photoconductors, and paper as well as toner transfer and control in laser printing and copier processes.

There is also a loss of information associated with the scanning process due to the way light is reflected and absorbed by the ink and paper and the optical and detector characteristics of the scanner. The scanner measures and records the average reflectance value at each pixel location within the image. The quality of the scanned and recorded image is a function of the resolution at which the image is scanned and the accuracy of the scanning device and detector measuring the reflected light.

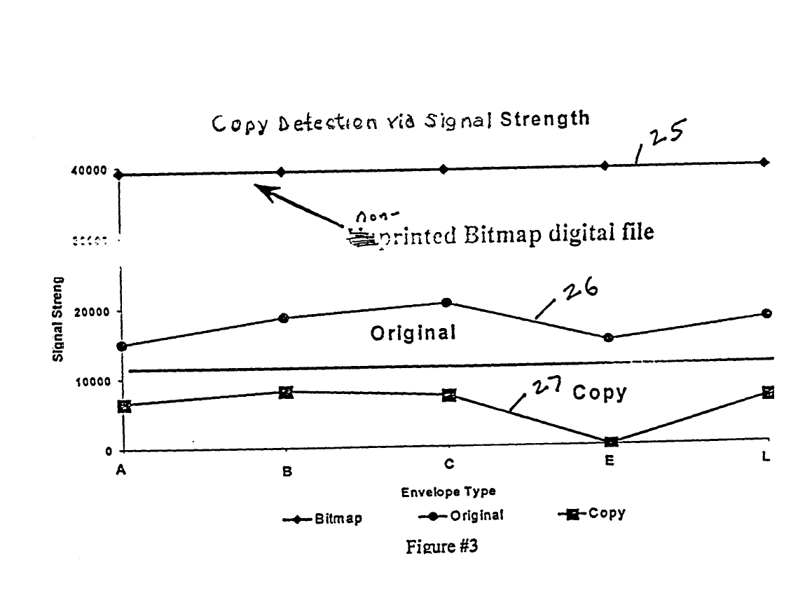

FIG. 3 is a graph of images produced on different envelope materials versus signal strength. The signal strength is calculated from the amount of information read from the watermark. Letters at the bottom of the graph indicate five different envelope types used in the test (A,B,C,E,L). Envelope type A is a white wove, 24 pound low ink absorbing envelope, and envelope type B is a white wove, 24 pound high ink absorbing envelope. Envelope type C is a 24 pound smooth finish envelope and envelope type E is a 32 pound 90 clasp envelope. Envelope type L is recycled white paper.

To make a copy of the original image 11, it is necessary to first scan, then reprint, image 11. The total loss of information associated with the copy process is the combined loss from the scanning and printing process. Signal value is a watermark quality metric calculated from the total information received by decoding a watermark. This information loss can be represented as a change in “signal strength”. An example of a maximum signal strength is shown by line 25 as the non-printed bit map digital file. Trace 26 indicates the signal strength of an original printed watermark, and trace 27 indicates the signal strength of a copy of the original watermark. The data show a significant decrease in the signal value of the watermark between the original and the copy (−56% to −100%). The substantial change in signal value makes it possible to discriminate between a copy and an original to accurately identify copies.

Signal Strength Measurements

TABLE 1

| | | | Difference | % change | | Difference | % change |
|---|---|---|---|---|---|---|---|
| | Bitmap | Original | Bitmap to | Bitmap to | | Original | Original |
| Envelope | (Maximum) | Print | Original | Original | Copy | to Copy | to Copy |
| A | 39208 | 14892 | 24316 | 62% | 6500 | 8392 | 56% |
| B | 39208 | 18577 | 20631 | 53% | 8153 | 10424 | 56% |
| C | 39208 | 20374 | 18834 | 48% | 7349 | 13025 | 64% |
| E | 39208 | 14860 | 24348 | 62% | 0 | 14861 | 100% |
| L | 39208 | 17749 | 21459 | 55% | 6590 | 11159 | 63% |

The envelopes selected for the measurement represent a range of paper types found in the mailing environment and demonstrate the feasibility of the invention used in applications where there is little control over the types of paper used to record images.

The information loss associated with the printing process may be identified by using a high quality scanner (to minimize scanning losses) to scan a printed representation of the watermark. This scanned image is then decoded, and the information content of the watermark recorded and represented by a signal strength measurement. In FIG. 3, the loss of information due to printing the “original image” is the difference between the bitmap signal strength and the original print signal strength (trace 25 and trace 26). The above table shows this difference is between 48% and 62%.

An implementation of the fragile watermark into images printed on documents that have value, such postal indicia, could include, but is not limited to, the use of the following system elements.

Embedder: An embedder is a software program used to take an original image and embed a fragile watermark into a composite image. The embedding process uses a mathematical transformation of the original image file to produce a pattern of pixels that can be decoded later with special reader software. Embedding software provides the ability to embed information with different degrees of redundancy. More redundant information makes a watermark easier to detect and decode; less redundancy makes a watermark more difficult to recognize and decode.

Scanning hardware: Scanning hardware or an image capture device is required to record the printed watermark in a digital format. The digital representation of the printed watermark is imported into the reader software package where it is processed and decoded. Hand-held, portable scanning devices similar to bar code readers are well suited for this application. These devices use CCD arrays similar to those found in digital cameras to capture and store an image in memory. Other devices that could be used to record digital representations of printed fragile watermarks include flat bed scanners, digital cameras, laser scanning devices, and linear CCD arrays mounted in in-line processing equipment.

Decoding (reading) software: Reading software is used to process the image by decoding the information in the watermark and providing a signal value as output, indicating the quality of the watermark and the integrity of the embedded information. This signal value is a measure of the fraction of information that can be decoded. High signal indicates less loss of information (original image); low signal value indicates a copy (more lost, or unrecoverable information). Decoding software provides the capability to establish a signal threshold above which an image is considered to be an original, and below which it is determined to be a copy (FIG. 3).

The above specification describes a new and improved method for increasing the security of a document by being able to detect when an image is copied. It is realized that the above description may indicate to those skilled in the art additional ways in which the principles of this invention may be used without departing from the spirit. Therefore, it is intended that this invention be limited only by the scope of the appended claims.

What is claimed is:

1. A method for embedding information in an image so that the image will have different information when the image is reproduced by a scanning or printing process, the method comprising the steps of:
embedding digital information in an image;
printing the embedded digital information and the image to produce a original printed image;
scanning the original printed image to obtain a digital image of the embedded information and the image;
determining the signal strength of the original image; and
comparing the signal strength of a printed image with the signal strength of the original printed image to determine whether or not the printed image is a copy of the original printed image.

2. The method claimed in claim 1, wherein the image is a postal indicia.

3. The method claimed in claim 1, wherein the image is a graphic.

4. The method claimed in claim 1, wherein a bit map file is created for the original printed image.

5. The method claimed in claim 1, wherein the comparing step further including the step of:
measuring the signal strength of the original printed image to set a threshold value for the original printed image and copies of the original printed image.

6. The method claimed in claim 5, whereby if the signal strength of a printed image is greater than the threshold value the printed image is the original printed image.

7. The method claimed in claim 5, whereby if the signal strength of a printed image is less than the threshold value the printed image is not the original printed image.
